(19) United States
(12) Patent Application Publication
(10) Pub. No.: US 2024/0126031 A1
(43) Pub. Date: Apr. 18, 2024

(54) OPTICAL FIBER CABLE AND OPTICAL COMMUNICATION SYSTEM INCLUDING THE SAME

(71) Applicant: SUMITOMO ELECTRIC INDUSTRIES, LTD., Osaka (JP)

(72) Inventors: Takayuki SHIMAZU, Osaka (JP); Takayuki YOKOCHI, Osaka (JP); Kenichiro OTSUKA, Osaka (JP)

(21) Appl. No.: 18/486,233

(22) Filed: Oct. 13, 2023

(30) Foreign Application Priority Data
Oct. 18, 2022 (JP) 2022-166800

(51) Int. Cl. G02B 6/44

(52) U.S. Cl. CPC G02B 6/4431; G02B 6/44524; G02B 6/44528; G02B 6/4477

(57) ABSTRACT

An optical fiber cable includes an optical fiber bundle including optical fibers and a protective member having a cylindrical shape and defining an internal space where the optical fiber bundle is accommodated. The optical fiber bundle being a single optical fiber bundle is accommodated in the internal space. The protective member includes a first cylindrical portion having a ring-shaped first cut and a second cylindrical portion having a second cut corresponding to the first cut, the second cylindrical portion being spaced from the first cylindrical portion. An end of a first optical fiber included in the optical fibers is pulled out to outside of the protective member from between the first cylindrical portion and the second cylindrical portion.

### CROSS REFERENCE TO RELATED APPLICATIONS

This application claims priority based on Japanese Patent Application No. 2022-166800 filed on Oct. 18, 2022, and the entire contents of the Japanese patent application are incorporated herein by reference.

### TECHNICAL FIELD

The present disclosure relates to an optical fiber cable and an optical communication system including the same.

### BACKGROUND

Japanese Unexamined Patent Application Publication No. 2001-116968 discloses an optical communication trunk line cable in which a plurality of optical core wires or tape optical core wires are covered with a sheath. Japanese Unexamined Patent Application Publication No. 2005-208193 discloses an optical microbox for connecting a branch cable branched from an optical trunk line cable to a termination cable. U.S. Pat. No. 10,371,917 discloses a data center including an optical fiber and the like.

### SUMMARY

An optical fiber cable according to one aspect of the present disclosure includes an optical fiber bundle including optical fibers and a protective member having a cylindrical shape and defining an internal space where the optical fiber bundle is accommodated. The optical fiber bundle being a single optical fiber bundle is accommodated in the internal space. The protective member includes a first cylindrical portion having a ring-shaped first cut and a second cylindrical portion having a second cut corresponding to the first cut, the second cylindrical portion being spaced from the first cylindrical portion. An end of a first optical fiber included in the optical fibers is pulled out to outside of the protective member from between the first cylindrical portion and the second cylindrical portion.

### BRIEF DESCRIPTION OF THE DRAWINGS

FIG. 1 is a schematic plan view of an optical communication system including an optical fiber cable according to an embodiment.

FIG. 2 is a schematic plan view of a primary part of an optical fiber cable.

FIG. 3 is a perspective view of a primary part of a trunk line cable.

FIG. 4 is a schematic cross-sectional view of a trunk line cable.

FIG. 5 is a plan view of a primary part of a trunk line cable.

Each of FIG. 6A, FIG. 6B and FIG. 6C is a diagram for explaining a branching method of an optical fiber cable.

Each of FIG. 7A and FIG. 7B is a diagram for explaining a branching method of an optical fiber cable.

FIG. 8 is a schematic plan view of a primary part of an optical fiber cable according to a modification.

FIG. 9 is a schematic plan view of a branch member according to a modification.

### DETAILED DESCRIPTION

### Problems to be Solved by the Present Disclosure

In the data center or the like described in U.S. Pat. No. 10,371,917, for example, the optical communication trunk line cable shown in Japanese Unexamined Patent Application Publication No. 2001-116968 is used. If necessary, a part of the optical core wires or the tape optical core wires included in the optical communication trunk line cable are branched. In such branching of the optical core wires, precise operations such as specifying the optical core wire to be branched and branching only the specified optical core wire are required. Therefore, there is a demand for an optical fiber cable capable of facilitating the branching operation.

### Effects of the Present Disclosure

An object of an aspect of the present disclosure is to provide an optical fiber cable capable of facilitating a branching operation of optical fibers.

### Description of Embodiments of Present Disclosure

First, the contents of embodiments of the present disclosure will be listed and explained.

[1] An optical fiber cable according to one aspect of the present disclosure includes an optical fiber bundle including optical fibers and a protective member having a cylindrical shape and defining an internal space where the optical fiber bundle is accommodated. The optical fiber bundle being a single optical fiber bundle is accommodated in the internal space. The protective member includes a first cylindrical portion having a ring-shaped first cut and a second cylindrical portion having a second cut corresponding to the first cut, the second cylindrical portion being spaced from the first cylindrical portion. An end of a first optical fiber included in the optical fibers is pulled out to outside of the protective member from between the first cylindrical portion and the second cylindrical portion.

In the optical fiber cable of [1], the single optical fiber bundle including a plurality of optical fibers is accommodated in the internal space of the protective member. Accordingly, when the internal space of the protective member is exposed, the position of each optical fiber included in the optical fiber bundle can be easily specified. Therefore, by using the optical fiber cable, it is possible to facilitate the branching operation of the optical fiber.

[2] In the optical fiber cable according to [1], the optical fiber bundle may include at least one of a ribbon fiber and an intermittent ribbon fiber, the ribbon fiber including at least part of the optical fibers, the intermittent ribbon fiber including at least part of the optical fibers. In this case, the optical fibers are less likely to be separately accommodated in the internal space. Therefore, the manufacturability of the optical fiber cable can be improved. In addition, the optical fiber cable can be miniaturized.

[3] In the optical fiber cable according to [1] or [2], the optical fiber bundle may include a binding member configured to bundle the optical fibers together. In this case, it is possible to prevent the optical fibers from being separately accommodated in the internal space.

[4] In the optical fiber cable according to any one of [1] to [3], the optical fiber bundle may occupy 60% or less of a cross-sectional area of the internal space in terms of proportion. In this case, the optical fiber bundle is less likely to be damaged during cutting the protective member.

[5] In the optical fiber cable according to any one of [1] to [4], the optical fiber cable may further include a protective tube. At least part of a portion of the first optical fiber, the portion being exposed from the protective member, may be covered by the protective tube. In this case, the portion of the first optical fiber exposed from the protective member is less likely to be damaged.

[6] In the optical fiber cable according to any one of [1] to [5], the optical fiber cable may further include a first connector connected to one end of each of optical fibers and a second connector connected to an end of the first optical fiber. In this case, optical communication through the optical fiber cable is satisfactorily performed.

[7] In the optical fiber cable according to any one of [1] to [6], the optical fiber cable may further include a branch member configured to cover an exposed portion of the optical fibers, the first cut, and the second cut, the exposed portion being positioned between the first cylindrical portion and the second cylindrical portion. The branch member may include a body portion and a strain relief configured to support the first optical fiber, the strain relief extending in an intersection direction that intersects an extension direction of the exposed portion. The strain relief may be provided to be rotatable with respect to the body portion. In this case, it is possible to suppress occurrence of breakage of the branch portion of the first optical fiber branched from the optical fiber bundle and the periphery thereof.

### Details of Embodiments of Present Disclosure

Specific examples of optical fiber cables according to an embodiment of the present disclosure will be described below with reference to the drawings. The present disclosure is not limited to these examples, but is defined by the scope of the claims, and is intended to include all modifications within the meaning and scope equivalent to the scope of the claims. In the following description, the same elements are denoted by the same reference numerals in the description of the drawings, and redundant description is omitted.

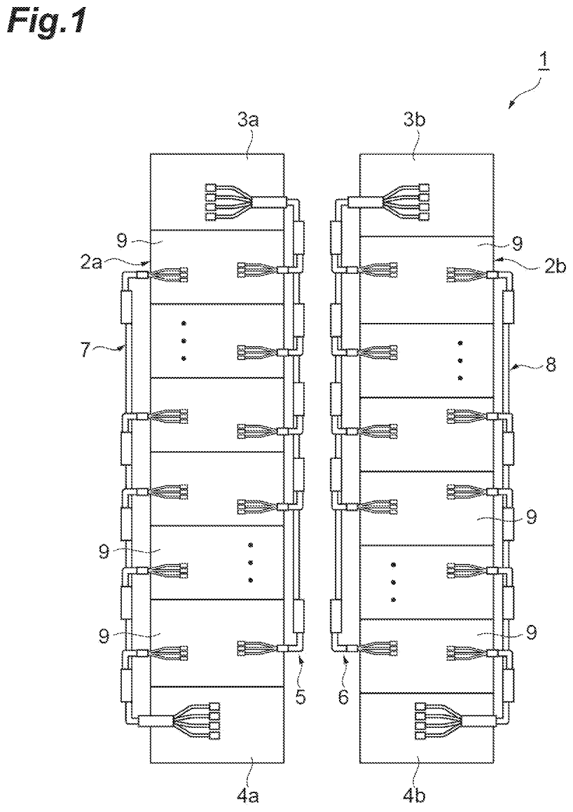

FIG. 1 is a schematic plan view of an optical communication system including an optical fiber cable according to an embodiment of the present disclosure. As shown in FIG. 1, an optical communication system 1 is a device group provided in a data center, a base station, or the like. Optical communication system 1 includes server rack groups 2a and 2b, currently used distribution frames 3a and 3b, standby distribution frames 4a and 4b, and optical fiber cables 5, 6, 7, and 8.

As shown in FIG. 1, each of server rack groups 2a and 2b has N server racks 9 (N is an integer equal to or greater than 2). In each of server rack groups 2a and 2b, N server racks 9 are arranged side by side along one direction in the plan view. Each server rack 9 is provided with shelves (not shown) arranged in the vertical direction. A physical server (not shown) or the like is placed on each of shelves. Hereinafter, the one direction is referred to as an arrangement direction.

Each of currently used distribution frames 3a and 3b and standby distribution frames 4a and 4b is a line concentrator that accommodates a communication line (optical fiber cable) used in optical communication system 1, and is also referred to as an intermediate distribution frame (IDF). Currently used distribution frame 3a is arranged at one end of server rack group 2a in the arrangement direction, and currently used distribution frame 3b is arranged at one end of server rack group 2b in the arrangement direction. Standby distribution frame 4a is arranged at the other end of server rack group 2a in the arrangement direction, and standby distribution frame 4b is arranged at the other end of server rack group 2b in the arrangement direction.

An external multi-core cable (not shown) constituting a currently used line is connected to each of currently used distribution frames 3a and 3b. In each of currently used distribution frames 3a and 3b, the external multi-core cable is divided and wired into communication lines. An external multi-core cable (not shown) constituting a standby line is connected to each of standby distribution frames 4a and 4b. In each of standby distribution frames 4a and 4b, the external multi-core cable is divided and wired into communication lines. Termination processing of an optical fiber cable may be performed in each of currently used distribution frames 3a and 3b and standby distribution frames 4a and 4b. A termination unit that holds multiple optical fiber wirings and accommodates a connection point may be mounted on each of currently used distribution frames 3a and 3b and standby distribution frames 4a and 4b. It should be noted that each of currently used distribution frames 3a and 3b and standby distribution frames 4a and 4b is not limited to the intermediate distribution frame.

Optical fiber cable 5 is a multi-core cable that connects server rack group 2a and currently used distribution frame 3a. Similarly, optical fiber cable 6 is a multi-core cable that connects server rack group 2b and currently used distribution frame 3b, optical fiber cable 7 is a multi-core cable that connects server rack group 2a and standby distribution frame 4a, and optical fiber cable 8 is a multi-core cable that connects server rack group 2b and standby distribution frame 4b. Optical fiber cables 5 and 6 are used as currently used lines, and optical fiber cables 7 and 8 are used as standby lines. Optical fiber cables 5, 6, 7, and 8 may have the same structure, or may have different structures from each other. In an embodiment of the present disclosure, optical fiber cables 5, 6, 7, and 8 have the same structure. Therefore, only optical fiber cable 5 will be described in detail below.

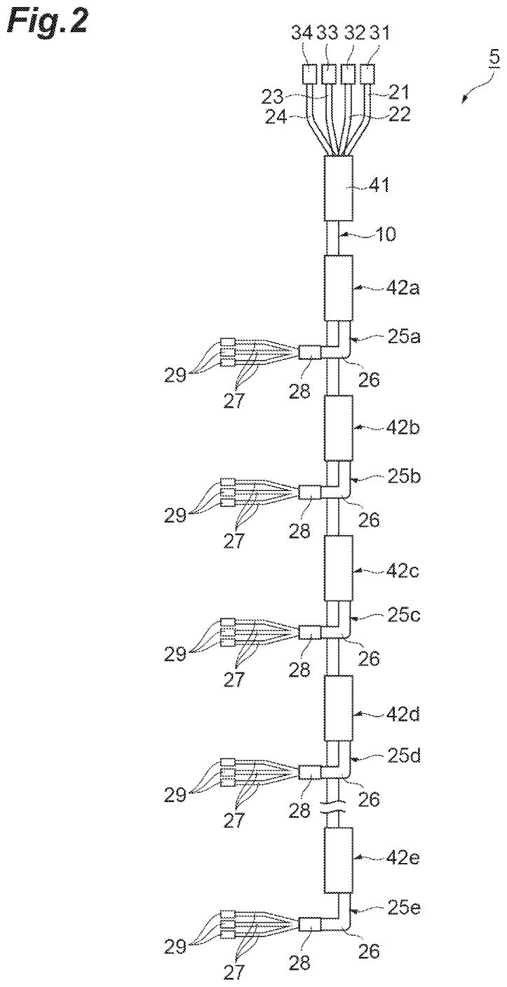

FIG. 2 is a schematic plan view of a primary part of an optical fiber cable. As shown in FIG. 2, optical fiber cable 5 includes a trunk line cable 10, multi-core optical fiber cords 21, 22, 23, and 24, branch optical fiber cables 25a, 25b, 25c, 25d, and 25e, connectors 31, 32, 33, and 34 (first connectors), a branch member 41, and branch members 42a, 42b, 42c, 42d, and 42e. Although the number of branch optical fiber cables is N in an example, branch optical fiber cables 25a, 25b, 25c, 25d, and 25e among the N branch optical fiber cables are shown in a simplified manner in FIG. 2. The same applies to branch members and the like.

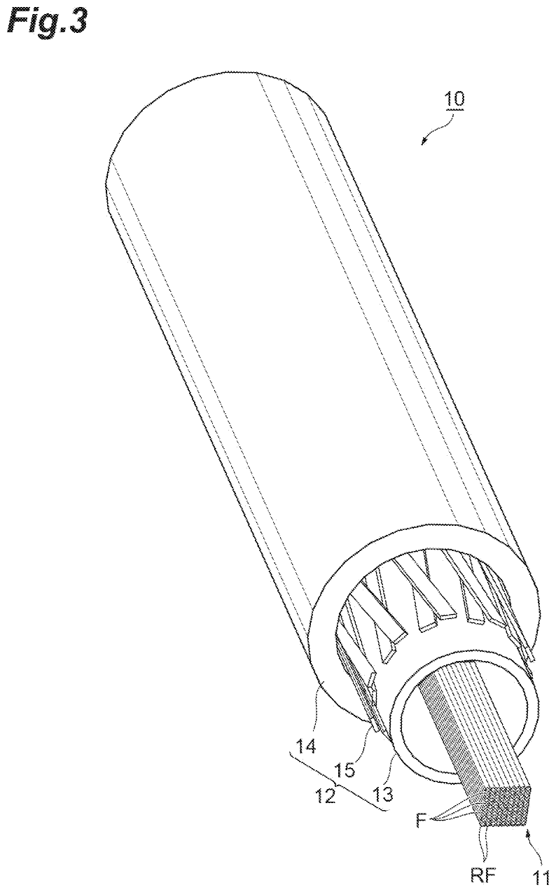

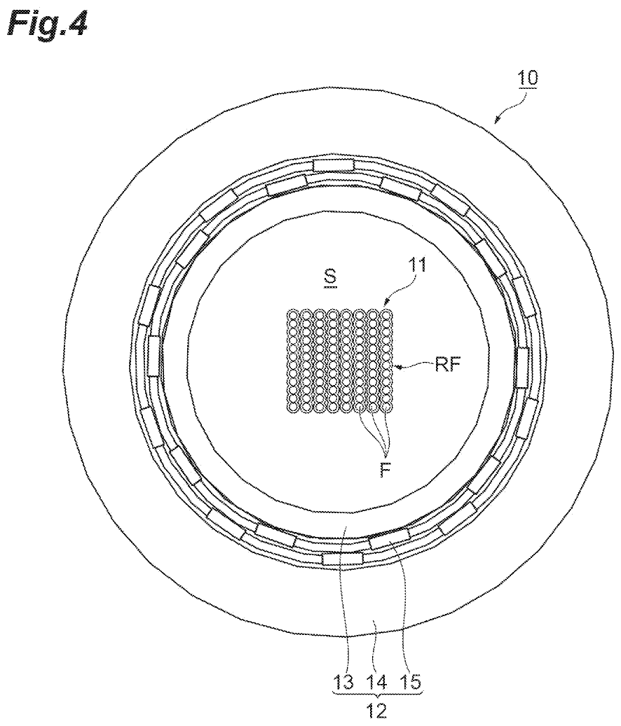

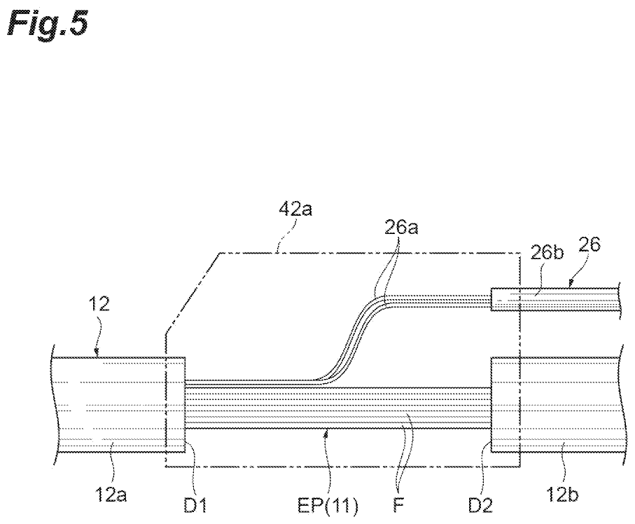

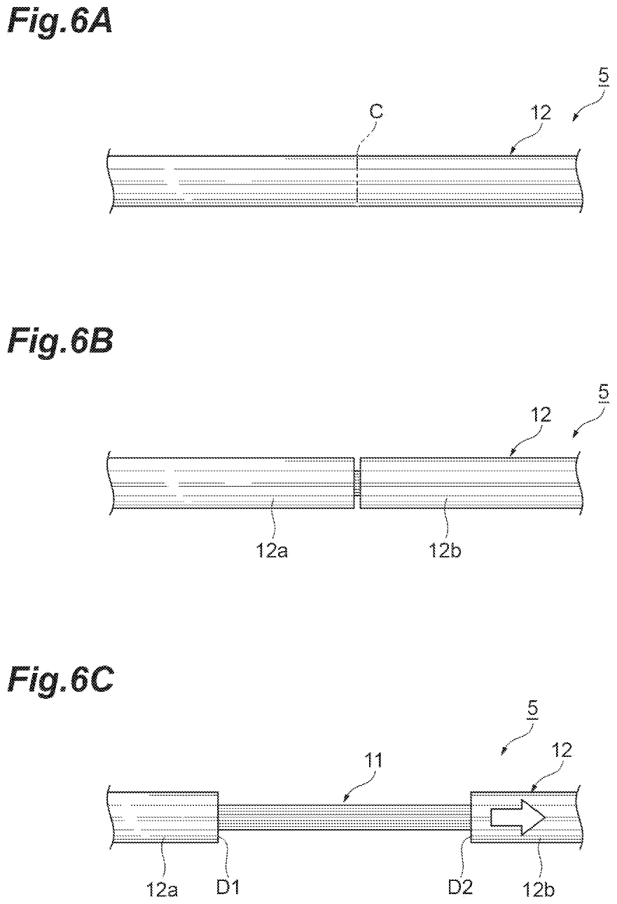

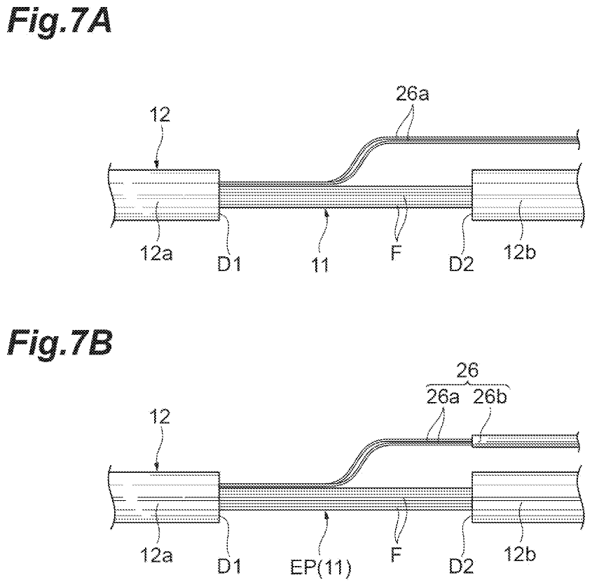

FIG. 3 is a perspective view of a primary part of a trunk line cable. FIG. 4 is a schematic cross-sectional view of a trunk line cable. FIG. 5 is a plan view of a primary part of a trunk line cable. In FIG. 3, a part of trunk line cable 10 is omitted. In FIG. 5, branch member 42a is omitted. One end of trunk line cable 10 is accommodated in branch member 41. More specifically, in trunk line cable 10, one end of a protective member 12 to be described later is accommodated in branch member 41.

As shown in FIGS. 3 and 4, trunk line cable 10 is a so-called slotless cable. Trunk line cable 10 includes an optical fiber bundle 11 including optical fibers F, and protective member 12 defining an internal space S accommodating optical fiber bundle 11. Single optical fiber bundle 11 is accommodated in internal space S. In an example, only the single optical fiber bundle 11 is accommodated in internal space S, but the present disclosure is not limited thereto. For example, in addition to the single optical fiber bundle 11, a buffer agent such as a resin may be accommodated in internal space S.

Optical fiber bundle 11 is an aggregate of optical fibers F and is a substantially single string-like member. Therefore, optical fiber bundle 11 corresponds to a cord including core wires. Each of optical fibers F is a member having one core wire. Each of optical fibers F may include, in addition to the core wire, a covering member that covers the core wire. From the viewpoint of suppressing damage to optical fiber bundle 11, optical fiber bundle 11 occupies, for example, 60% or less of a cross-sectional area of internal space S in terms of proportion. The proportion may be, for example, 50% or less, 40% or less, or 30% or less. From the viewpoint of being connectable to a large number of server rack groups 2a, the proportion is, for example, 10% or more.

At least part of optical fibers F included in optical fiber bundle 11 may be formed into a taped shape. For example, a ribbon fiber or an intermittent ribbon fiber may be formed by ribbonizing some optical fibers among optical fibers F. The ribbon fiber is a member in which optical fibers arranged in a row are fixed to each other by resin or the like. The intermittent ribbon fiber is a member having both a portion (adhesive portion) where optical fibers are fixed to each other and a portion (single-core portion) where optical fibers are separated from each other. In an example, optical fiber bundle 11 includes eight ribbon fibers RF, and each ribbon fiber RF includes twelve optical fibers F, but is not limited thereto. For example, optical fiber bundle 11 may include only the intermittent ribbon fiber, or may include both ribbon fiber RF and the intermittent ribbon fiber. Alternatively, optical fibers F included in optical fiber bundle 11 may be separated from each other. That is, optical fibers F may be loose wires. In this case, optical fiber bundle 11 may include a binding member that binds optical fibers F. The binding member is, for example, a string, a band, a mesh tube or the like.

Protective member 12 is a cylindrical member that protects optical fiber bundle 11 and has flexibility. Protective member 12 includes a tube 13, an outer covering 14 that covers tube 13, and an interposition member 15 located between tube 13 and outer covering 14. Tube 13 is a cylindrical resin member defining the inner peripheral surface of protective member 12. Thus, the inner diameter of tube 13 corresponds to the inner diameter of protective member 12. Outer covering 14 is a cylindrical resin member defining the outer peripheral surface of protective member 12. Interposition member 15 is a member for relaxing stress applied to protective member 12, and is, for example, a mesh tube.

As shown in FIG. 5, protective member 12 has a first cylindrical portion 12a and a second cylindrical portion 12b spaced apart from each other in the extending direction of optical fiber cable 5. First cylindrical portion 12a and second cylindrical portion 12b are formed by dividing protective member 12, for example. Thus, first cylindrical portion 12a has a ring-shaped first cut D1. Second cylindrical portion 12b also has a ring-shaped second cut D2 corresponding to first cut D1 (see also FIG. 3). In an example, first cut D1 and second cut D2 can be fitted with each other, but are not limited thereto. The shape of first cut D1 and the shape of second cut D2 may be different from each other. In optical fibers F included in optical fiber bundle 11, a portion positioned between first cylindrical portion 12a and second cylindrical portion 12b is an exposed portion EP exposed from protective member 12.

Referring back to FIG. 2, each of multi-core optical fiber cords 21, 22, 23, and 24 is a communication line positioned between currently used distribution frame 3a and branch member 41 in the extending direction of optical fiber cable 5. Each of multi-core optical fiber cords 21, 22, 23, and 24 is a cord including part of optical fibers F. The number of cores included in each of multi-core optical fiber cords 21, 22, 23, and 24 may be equal to the number obtained by dividing the number of optical fibers F in trunk line cable 10 by the number of multi-core optical fiber cords 21, 22, 23, and 24. In an example, each of multi-core optical fiber cords 21, 22, 23, and 24 is a 24-core cord. One end of multi-core optical fiber cord 21 is connected to connector 31. Similarly, one end of each of multi-core optical fiber cords 22, 23, and 24 is connected to connectors 32, 33, and 34, respectively. The other end of each of multi-core optical fiber cords 21, 22, 23, and 24 is accommodated in branch member 41. Each of multi-core optical fiber cords 21, 22, 23, and 24 is reinforced by, for example, a reinforcing tube. Each one end of multi-core optical fiber cord 21, 22, 23, and 24 corresponds to one ends of optical fibers F.

Each of branch optical fiber cables 25a, 25b, 25c, 25d, and 25e is a communication line connected to server rack group 2a. Each of branch optical fiber cables 25a, 25b, 25c, 25d, and 25e has the same configuration. Therefore, as shown in FIGS. 2 and 5, each of branch optical fiber cables 25a, 25b, 25c, 25d, and 25e includes a branch trunk line cable 26, optical fiber cords 27, a branch member 28, and connectors 29 (second connectors). Hereinafter, only branch optical fiber cable 25a will be described in detail. The lengths of branch optical fiber cables 25a, 25b, 25c, 25d, and 25e may be different from each other.

Branch trunk line cable 26 is a trunk line of branch optical fiber cable 25a. As shown in FIG. 5, branch trunk line cable 26 is pulled out to the outside of protective member 12 from between first cylindrical portion 12a and second cylindrical portion 12b. Branch trunk line cable 26 includes branch optical fibers 26a (first optical fibers) and a protective tube 26b covering branch optical fibers 26a. Each of branch optical fibers 26a corresponds to optical fiber F branched from optical fiber bundle 11. That is, each branch optical fiber 26a before branching corresponds to one of optical fibers F included in optical fiber bundle 11. Protective tube 26b is a cylindrical member that covers at least part of portions of branch optical fibers 26a exposed from protective member 12, and has flexibility. In an example, protective tube 26b covers at least a portion of branch optical fibers 26a exposed from protective member 12, branch member 28, or a branch member 42a.

Each of optical fiber cords 27 is a cord including a part of branch optical fibers 26a. In an example, branch optical fiber cable 25a includes three optical fiber cords 27, but is not limited thereto. For example, when the total number of branch optical fibers 26a is six, two branch optical fibers 26a are accommodated in each optical fiber cord 27. Therefore, each optical fiber cord 27 has fewer core wires (not shown) than branch trunk line cable 26. Each optical fiber cord 27 may have a protective tube for protecting the core wires.

Branch member 28 is a member for protecting a portion branched from branch trunk line cable 26 to optical fiber cords 27. In branch member 28, a part of branch optical fibers 26a may be exposed from protective tube 26b.

Each of connectors 29 is an interface connected to server rack group 2a. Each connector 29 is, for example, a data link connector and is connected to the corresponding optical fiber cord 27. Therefore, connectors 29 are members connected to the ends of branch optical fibers 26a, respectively. Therefore, it can be said that each end of branch optical fibers 26a is pulled out to the outside of protective member 12 from between first cylindrical portion 12a and second cylindrical portion 12b. The number of optical fibers (the number of cores) coupled to connector 29 corresponds to the number of optical fibers included in optical fiber cord 27.

Each of connectors 31, 32, 33, and 34 is an interface connected to currently used distribution frame 3a. Each of connectors 31, 32, 33, and 34 is, for example, a multi-fiber push-on connector (MPO connector). In this case, the number of optical fibers (the number of cores) coupled to connector 31 corresponds to the number of optical fibers included in multi-core optical fiber cord 21. The same applies to connectors 32, 33, and 34.

Branch member 41 is a member that accommodates a portion branched from multi-core optical fiber cords 21, 22, 23, and 24 to optical fibers F. A cavity is formed in branch member 41, and the other ends of multi-core optical fiber cords 21, 22, 23, and 24 are accommodated in the cavity. The respective positions of multi-core optical fiber cords 21, 22, 23, and 24 may be fixed in branch member 41. In branch member 41, each ribbon fiber RF is exposed by removing reinforcing tubes or the like provided in multi-core optical fiber cords 21, 22, 23, and 24. Each ribbon fiber RF may be bundled by a binding member or the like. In addition, since there is no portion of being fusion-spliced (fusion-spliced portion) between multi-core optical fiber cords 21, 22, 23, 24 and ribbon fibers RF, the optical loss is less likely to occur in branch member 41. In branch member 41, the position of each ribbon fiber RF and the position of multi-core optical fiber cords 21, 22, 23, and 24 may be fixed. In branch member 41, the fusion-spliced portions between multi-core optical fiber cord 21 and some ribbon fibers RF may be formed. In this case, branch member 41 also functions as a protective member of the fusion-spliced portion and the like.

Branch member 42a is a member (case for optical fiber cable) for protecting exposed portion EP of optical fibers F, the branching position of branch optical fiber cable 25a, and the exposed portion of the branch optical fibers 26a. Branch member 42b at least protects the branching position of branch optical fiber cable 25b, branch member 42c at least protects the branching position of branch optical fiber cable 25c, and branch member 42d at least protects the branching position of branch optical fiber cable 25d. Branch member 42e at least protects the branching position of branch optical fiber cable 25e. In an example, branch member 42a at least covers exposed portion EP, the exposed portion of branch optical fiber 26a, first cut D1 of first cylindrical portion 12a, second cut D2 of second cylindrical portion 12b, and a part of protective tube 26b. Each of branch members 42a, 42b, 42c, 42d, and 42e is, for example, a resin molded body. At least part of each of branch members 42a, 42b, 42c, 42d, and 42e may have elasticity. In an example, an example of a specific configuration for branch members 42a, 42b, 42c, 42d, and 42e is the branch protection case shown in Japanese Patent Application No. 2021-197035.

Hereinafter, an example of a branching method of optical fiber cable 5 according to the embodiment of the present disclosure will be described with reference to FIGS. 6A, 6B, 6C, 7A and 7B. Each of FIG. 6A, FIG. 6B and FIG. 6C, and FIG. 7A and FIG. 7B is a diagram for explaining a branching method of an optical fiber cable.

First, as shown in FIG. 6A, a portion to be cut (an intended-to-be cut portion C) is determined on protective member 12 of optical fiber cable 5. Subsequently, as shown in FIG. 6B, protective member 12 is cut along intended-to-be cut portion C. Accordingly, first cylindrical portion 12a and second cylindrical portion 12b are separated from each other. For example, tube 13, outer covering 14, and interposition member 15 of protective member 12 can be selectively cut by using a sheath cutter or the like. In other words, protective member 12 can be cut without damaging optical fiber bundle 11. Subsequently, as shown in FIG. 6C, only second cylindrical portion 12b is slid along the extending direction of optical fiber cable 5. Accordingly, second cylindrical portion 12b is moved away from first cylindrical portion 12a, and the distance between first cut D1 and second cut D2 in the extending direction is increased. Then, a part of optical fiber bundle 11 is exposed.

Next, as shown in FIG. 7A, a part of optical fibers F included in optical fiber bundle 11 is branched. Thus, branch optical fibers 26a are separated from optical fiber bundle 11, from between first cylindrical portion 12a and second cylindrical portion 12b. At this time, each end (not shown) of branch optical fibers 26a is extracted from between first cylindrical portion 12a and second cylindrical portion 12b to the outside of protective member 12. From the viewpoint of simplification of subsequent steps, a part of the extracted branch optical fibers 26a may be cut off. Thus, the extra length processing of branch optical fibers 26a can be easily performed. Subsequently, as shown in FIG. 7B, branch optical fibers 26a are inserted into protective tube 26b. Thus, branch trunk line cable 26 is formed. Although not shown here, connector 29 is attached to the ends of branch optical fibers 26a. Subsequently, as shown in FIG. 5, branch member 42a covering exposed portion EP of optical fiber bundle 11, the exposed portions of branch optical fibers 26a, first cut D1 of first cylindrical portion 12a, second cut D2 of second cylindrical portion 12b, and a part of protective tube 26b is attached to optical fiber cable 5. By repeating the above steps, optical fiber cable 5 provided with branching points can be manufactured.

In optical fiber cable 5 according to the embodiment of the present disclosure described above, the single optical fiber bundle 11 including optical fibers F is accommodated in internal space S of protective member 12. Thus, when internal space S of protective member 12 is exposed, the position of each optical fiber F included in optical fiber bundle 11 can be easily specified. Therefore, by using optical fiber cable 5, it is possible to facilitate the branching operation of optical fibers F.

In an example, optical fiber bundle 11 includes ribbon fiber RF including at least part of optical fibers F. Therefore, optical fibers F are less likely to be separately accommodated in internal space S. Optical fiber bundle 11 may include an intermittent ribbon fiber including at least part of optical fibers F. Also in this case, the same operational effect is exhibited.

In an example, optical fiber bundle 11 may include a binding member that bundles optical fibers F. In this case, it is possible to prevent optical fibers F from being separately accommodated in internal space S. In addition, even when each optical fiber F is accommodated in protective member 12 by a single wire, each optical fiber F can be easily specified.

In an example, optical fiber bundle 11 may occupy 60% or less of the cross-sectional area of internal space S in terms of proportion. In this case, optical fiber bundle 11 is less likely to be damaged when protective member 12 is cut or the like. In addition, second cylindrical portion 12b of protective member 12 can be slid along the extending direction of optical fiber cable 5 without damaging optical fiber bundle 11.

In an example, at least part of a portion of branch optical fibers 26a exposed from protective member 12 is covered by protective tube 26b. Therefore, the portion of branch optical fibers 26a exposed from the protective member is less likely to be damaged.

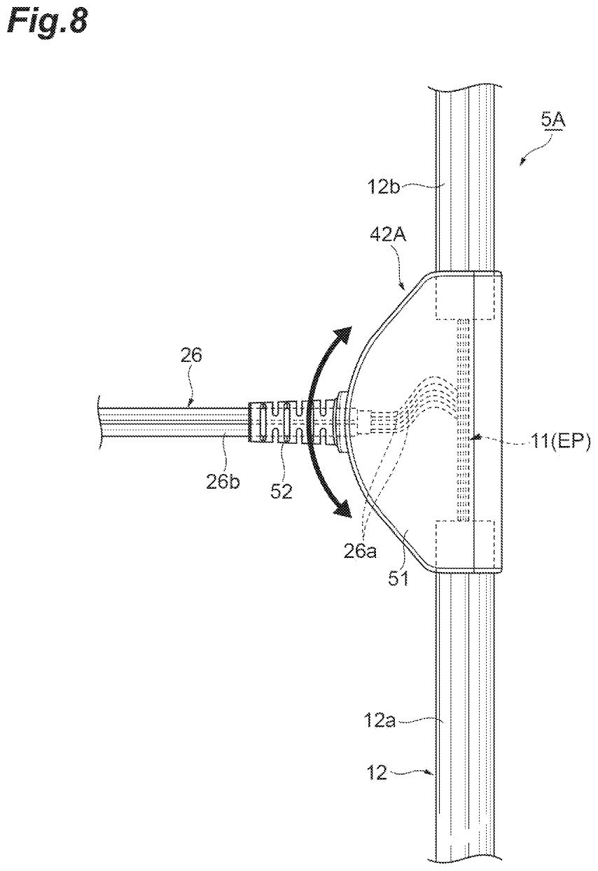

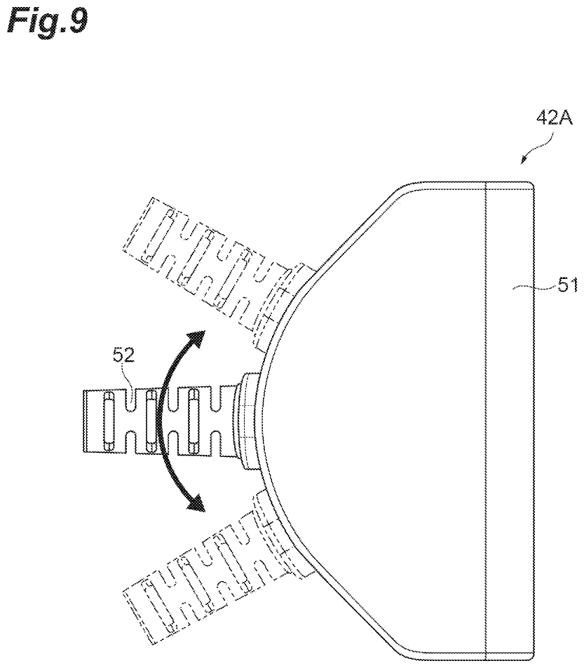

Hereinafter, a branch member of an optical fiber cable according to a modification will be described with reference to FIGS. 8 and 9. In the description of the modification, the description overlapping with the above embodiment will be omitted, and portions different from the above embodiment will be described. In other words, the description of the above embodiment may be appropriately used for the modification within a technically possible range.

FIG. 8 is a schematic plan view of a primary part of an optical fiber cable according to the modification. FIG. 9 is a schematic plan view of a branch member according to the modification. As shown in FIGS. 8 and 9, a branch member 42A included in an optical fiber cable 5A according to the modification includes a body portion 51 and a strain relief 52 for supporting branch optical fibers 26a. Body portion 51 is a portion that protects exposed portion EP of optical fibers F, the branching position of branch optical fiber cable 25a, and the exposed portion of branch optical fibers 26a. The extra length portions of branch optical fibers 26a are accommodated in body portion 51. Therefore, branch optical fibers 26a in body portion 51 may be bent. Strain relief 52 is a member provided to be rotatable with respect to body portion 51, and extends in a direction (intersecting direction) intersecting the extending direction of exposed portion EP. The movable range of strain relief 52 with respect to body portion 51 is defined by, for example, a stopper (not shown) provided in body portion 51. When it is defined that strain relief 52 positioned in the direction orthogonal to the extending direction is positioned at 0°, strain relief 52 is rotatable within a range of ±30°, for example.

Also in the modification described above, the same operational effects as those of the embodiment described above can be obtained. In addition, it is possible to suppress occurrence of breakage of the branch portion of branch optical fibers 26a from optical fiber bundle 11 and the periphery thereof. In addition, the extending direction of branch optical fiber cable 25a can be easily adjusted.

The optical fiber cable according to the present disclosure is not limited to the above-described embodiments and modifications, and various other modifications are possible. For example, in the above-described embodiment and modification, one ends of four multi-core optical fiber cords are accommodated in the branch member, but the present disclosure is not limited thereto. For example, instead of the multi-core optical fiber cord, one ends of three or less optical fibers may be accommodated in the branch member, or one ends of five or more optical fibers may be accommodated in the branch member.

What is claimed is:

1. An optical fiber cable comprising:
an optical fiber bundle including optical fibers; and
a protective member having a cylindrical shape and defining an internal space where the optical fiber bundle is accommodated,
wherein the optical fiber bundle being a single optical fiber bundle is accommodated in the internal space,
wherein the protective member includes a first cylindrical portion having a ring-shaped first cut and a second cylindrical portion having a second cut corresponding to the first cut, the second cylindrical portion being spaced from the first cylindrical portion, and
wherein an end of a first optical fiber included in the optical fibers is pulled out to outside of the protective member from between the first cylindrical portion and the second cylindrical portion.

2. The optical fiber cable according to claim 1,
wherein the optical fiber bundle includes at least one of a ribbon fiber and an intermittent ribbon fiber, the ribbon fiber including at least part of the optical fibers, the intermittent ribbon fiber including at least part of the optical fibers.

3. The optical fiber cable according to claim 1,
wherein the optical fiber bundle includes a binding member configured to bundle the optical fibers together.

4. The optical fiber cable according to claim 1,
wherein the optical fiber bundle occupies 60% or less of a cross-sectional area of the internal space in terms of proportion.

5. The optical fiber cable according to claim 1,
wherein the optical fiber bundle occupies from 10% to 60% of a cross-sectional area of the internal space in terms of proportion.

6. The optical fiber cable according to claim 1, further comprising a protective tube,
wherein at least part of a portion of the first optical fiber, the portion being exposed from the protective member, is covered by the protective tube.

7. The optical fiber cable according to claim 1, further comprising:
a first connector connected to one end of each of the optical fibers; and
a second connector connected to the end of the first optical fiber.

8. The optical fiber cable according to claim 1, further comprising:
a branch member configured to cover an exposed portion of the optical fibers, the first cut, and the second cut, the exposed portion being positioned between the first cylindrical portion and the second cylindrical portion,
wherein the branch member includes a body portion and a strain relief configured to support the first optical fiber, the strain relief extending in an intersection direction that intersects an extension direction of the exposed portion, and
wherein the strain relief is rotatable with respect to the body portion.

9. An optical communication system comprising:
a server rack group including server racks;
a distribution frame; and
the optical fiber cable according to claim 1, the optical fiber cable connecting the server rack group and the distribution frame.

10. An optical fiber cable comprising:
a protective tube defining an internal space; and
optical fibers bundled each other in the internal space,
wherein the protective tube includes a first portion having a first cut and a second portion having a second cut corresponding to the first cut, the second portion being spaced from the first portion, and
wherein an end of a first optical fiber included in the optical fibers is extracted to outside of the protective tube from between the first portion and the second portion.

11. The optical fiber cable according to claim 10,
wherein at least part of the optical fibers are ribbonized or intermittently ribbonized.

12. The optical fiber cable according to claim 10,
wherein the optical fibers are bundled by a binding member.

13. The optical fiber cable according to claim 10,
wherein the optical fibers occupy 60% or less of a cross-sectional area of the internal space in terms of proportion.

14. The optical fiber cable according to claim 10,
wherein the optical fibers occupy from 10% to 60% of a cross-sectional area of the internal space in terms of proportion.

15. The optical fiber cable according to claim 10, further comprising a second protective tube,
wherein at least part of a portion of the first optical fiber, the portion being exposed from the protective tube, is covered by the second protective tube.

16. The optical fiber cable according to claim 10, further comprising:
a first connector connected to one end of each of the optical fibers; and
a second connector connected to the end of the first optical fiber.

17. The optical fiber cable according to claim 10, further comprising:
a branch member configured to cover an exposed portion of the optical fibers, the first cut, and the second cut, the exposed portion being positioned between the first portion and the second portion,
wherein the branch member includes a body portion and a strain relief configured to support the first optical fiber, the strain relief extending in an intersection direction that intersects an extension direction of the exposed portion, and
wherein the body portion rotatably supports the strain relief.
